(19) United States
(12) Patent Application Publication
(10) Pub. No.: US 2014/0100941 A1
(43) Pub. Date: Apr. 10, 2014

(54) Vehicular Part Transaction System and Method

(71) Applicant: NICHOLAS KEITH IRISH, FORT MYERS, FL (US)

(72) Inventor: NICHOLAS KEITH IRISH, FORT MYERS, FL (US)

(21) Appl. No.: 14/051,306

(22) Filed: Oct. 10, 2013

Related U.S. Application Data
(60) Provisional application No. 61/795,103, filed on Oct. 10, 2012.

(51) Int. Cl. G06Q 30/06; G06Q 30/02

(52) U.S. Cl. CPC G06Q 30/0611; G06Q 30/0236
USPC 705/14.36; 705/26.4

(57) ABSTRACT

A vehicular part transaction system and method. A transaction coordinator can receive a part request from a purchaser via a computer network; send a respective bid invitation to sellers via the network; store associated sent-timestamps based on when bids are sent; receive a part offer from one of the sellers via the computer network; forward the offer to purchaser via the network; receive an acceptance from purchaser via the network; determine a transaction for part offer; charge the seller the transaction fee; and forward an acceptance notice, via the network, to the purchaser and seller. The transaction fee can be reduced for a fast response time. Optionally, a seller and/or a purchaser can be subscribed, which can independently provide a respective benefit thereto and/or can conditionally provide a respective benefit thereto.

### CROSS-REFERENCE TO RELATED DOCUMENTS

This application is related to, claims the priority benefit of, and incorporates by reference in its entirety, U.S. Provisional Patent Application Ser. No. 61/795,103, entitled “Vehicular Part Transaction System and Method,” and filed on Oct. 10, 2012 by Inventor, Nicholas Keith Irish.

### BACKGROUND OF THE INVENTION

Vehicles are devices used to transport persons and/or things from one location to another. It can be important for vehicles to be operable due to transportation requirements. To maintain operability, vehicles can require replacement parts. Replacement parts can be difficult to obtain in a timely manner due to shipping logistics, and scarcity of such parts, and especially as vehicles become dated.

### SUMMARY OF THE INVENTION

It is an object of the present invention to a vehicular part transaction system and method, such a system and method having a plurality of embodiments, which are described, and are to be broadly interpreted, via the disclosure herein.

In an exemplary embodiment of the present invention, in a computer system, a method of facilitating a vehicular part transaction by a transaction coordinator can include the following: receiving a part request from a part purchaser via a computer network, the part request including part identification data; sending a respective bid invitation having the part identification data to a plurality of part sellers via the computer network; for each respective bid invitation, storing an associated sent-timestamp based at least in part on when the respective bid invitation is sent; receiving from one of the plurality of part sellers, via the computer network, a part offer having price data and a seller response time associated therewith, the seller response time being determined at least in part by when the part offer is received and the stored sent-timestamp associated with the respective bid invitation sent to the one of the plurality of part sellers; forwarding the part offer, via the computer network, to the part purchaser; receiving from the part purchaser, via the computer network, an acceptance of the part offer; determining a transaction fee associated with the accepted part offer; charging the one of the plurality of part sellers the transaction fee; and forwarding an acceptance notice, via the computer network, to at least one of the part purchaser and the one of the plurality of part sellers. In a basic exemplary aspect of the present invention, determination of the transaction fee can include reducing the transaction fee if the seller response time associated with the accepted part offer is within a seller bonus time.

In exemplary optional aspects of the present invention, a seller can be a subscribed seller, in which case such a method can further include issuing a seller bonus to the one of the plurality of part sellers if the one of the plurality of part sellers is a subscribed seller; and/or reducing the transaction fee and/or reducing the transaction fee.

In another exemplary optional aspect of the present invention, such a method can further include the following: after the acceptance is received, determining a purchaser fee associated with the accepted part offer; and charging the purchaser fee to the part purchaser. With such an optional aspect, such a method can further include any one or more of the following further optional aspects:
before the acceptance is received, storing an issued-timestamp based at least in part on when the respective bid invitation is sent, with the acceptance of the part offer having a purchaser response time associated therewith, and the purchaser fee determination including reducing the purchaser fee if the purchaser response time associated with the acceptance is within a purchaser bonus time;
reducing the purchaser fee to zero if the purchaser is a subscribed purchaser;
reducing the purchaser fee zero if the purchaser is a subscribed purchaser and a number of completed transactions associated with the purchaser is within an allotted number of purchases associated with the purchaser;
reducing the purchaser fee if the purchaser is a subscribed purchaser and a total fee amount charged to the purchaser is less than an allotted amount associated with the purchaser; and
reducing the purchaser fee to zero if the purchaser is a subscribed purchaser and a total fee amount charged to the purchaser plus the transaction fee is less than an allotted amount associated with the purchaser.

In another exemplary aspect of the present invention, the transaction fee can be reduced to zero if the part seller is a subscribed seller.

In a further exemplary aspect of the present invention, the transaction fee can reduced to zero if the part seller is a subscribed seller and a number of completed transactions associated with the part seller is within an allotted number of transactions.

In yet another exemplary aspect of the present invention, the transaction fee can be reduced if the part seller is a subscribed seller and a total fee amount charged to the one of the plurality of part sellers is less than an allotted amount associated with the part seller.

In still another exemplary aspect of the present invention, the transaction fee can be reduced to zero if the part seller is a subscribed seller and a total fee amount charged to the part seller plus the transaction fee is less than an allotted amount associated with the part seller.

In still a further exemplary aspect of the present invention, a method having an optional seller bonus can further include the following: after the acceptance is received, determining a purchaser fee associated with the accepted part offer; and charging the purchaser fee to the part purchaser. With such a further exemplary aspect, such a method can further include any one or more of the following additional optional aspects:
before the acceptance is received, storing an issued-timestamp based at least in part on when the respective bid invitation is sent, with the acceptance including a purchaser response time associated therewith, and the determination of the purchaser fee including reducing the purchaser fee if the purchaser response time associated with the acceptance is within a purchaser bonus time;
the purchaser fee can be reduced to zero if the purchaser is a subscribed purchaser;
the purchaser fee can be reduced to zero if the purchaser is a subscribed purchaser and a number of completed transactions associated with the purchaser is within an allotted number of purchases associated with the purchaser;
the purchaser fee can be reduced if the purchaser is a subscribed purchaser and a total fee amount charged to the purchaser is less than an allotted amount associated with the purchaser; and
the purchaser fee can be reduced to zero if the purchaser is a subscribed purchaser and a total fee amount charged to the purchaser plus the transaction fee is less than an allotted amount associated with the purchaser.

### BRIEF DESCRIPTION OF THE DRAWINGS

FIG. 1 illustrates a basic embodiment of the present invention in which a part purchaser 110, a transaction coordinator 120, and a plurality of part sellers 130_{1-I}, where i≧2, are communicationally related.

FIG. 2 illustrates a basic exemplary embodiment of the present invention carried out by a transaction coordinator.

FIG. 3 illustrates another exemplary embodiment of the present invention with an optional seller bonus issuance for subscribed sellers (block 245).

FIG. 4 illustrates another exemplary embodiment of the present invention with an optional purchaser fee determination (block 250) and optional charging thereof to a purchaser (block 255).

FIG. 5 illustrates another exemplary embodiment of the present invention with an optional issued-timestamp storage (block 260).

FIG. 6 illustrates another exemplary embodiment of the present invention with an optional seller bonus issuance (block 265) for a subscribed seller.

FIG. 7 illustrates another exemplary embodiment of the present invention with an optional issued-timestamp storage (block 260) in conjunction with optional seller bonus award for a subscribed seller (block 265).

### DETAILED DESCRIPTION

It is an object of the present invention to provide a vehicular part transaction system and method, such a system and method having a plurality of embodiments, which are described, and are to be broadly interpreted, via the disclosure herein.

It should be noted that this disclosure includes a plurality of elements and/or aspects, and such elements and/or aspects need not necessarily be interpreted as being conjunctively required by one or more embodiments of the present invention. Rather, all combinations of the one or more elements and/or aspects can potentially enable a separate embodiment of the present invention, which may be claimed with particularity in this or any future filed applications. Moreover, any particular elements, limitations, and/or aspects disclosed herein, whether expressly or implicitly, are to be strictly construed as illustrative and enabling, and not limiting. Therefore, it is expressly set forth that such elements, limitations, and/or aspects, independently or in any combination thereof, are merely illustratively representative of one or more embodiments of the present invention and are not to be construed as necessary in a strict sense.

Further, to the extent the same element, limitation, or aspect is defined differently anywhere within this disclosure, whether expressly or implicitly, the broader definition is to take absolute precedence, with any narrowing distinctions encompassed by the narrower definition to be strictly construed as optional. Moreover, it is expressly stated that any steps illustratively shown in any Figures are not to be construed as necessarily occurring in any particular order, unless expressly stated or necessarily required for logical coherency.

Illustratively, perceived benefits of the present invention can include functional utility, whether expressly or implicitly stated herein, or apparent herefrom. However, it is expressly set forth that these benefits are not intended as exclusive. Therefore, any explicit, implicit, or apparent benefit from the disclosure herein is expressly deemed as applicable to the present invention.

The present invention provides a vehicular part transaction system and method. According to the present invention, such a system can include a transaction coordinator as disclosed herein, with accompanying functionality and communicative environmental aspects as disclosed and as apparent herefrom.

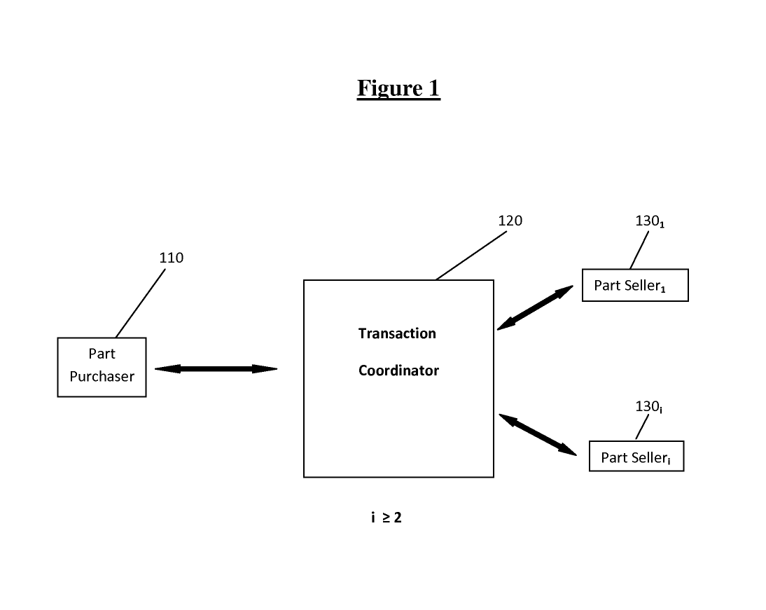

The present invention can be utilized with any type of communication network or networks through which information can be communicated between a part purchaser, a transaction coordinator, and a plurality of part sellers. For example and not in limitation, such a network can include any combination of the following: the Internet, a computer network, a mobile phone network, a satellite communication network, etc. FIG. 1 illustrates an exemplary environment of the present invention, in which a part purchaser 110, a transaction coordinator 120, and a plurality of part sellers 130₁₋ᵢ, where i≧2.

Further, the present invention can be implemented with any form of computer having a processor, a memory, an user interface, and a network interface. Exemplary computers can include a desktop computer, a notebook computer, a tablet, a smart phone, etc. Moreover, the present invention can be effectuated via one or more software programs executing on one or more computers, cooperatively forming a transaction coordinator. Notably, throughout this disclosure, any information can be stored in any one or more dynamic or static memories, and can include any information from which desired information can be derived.

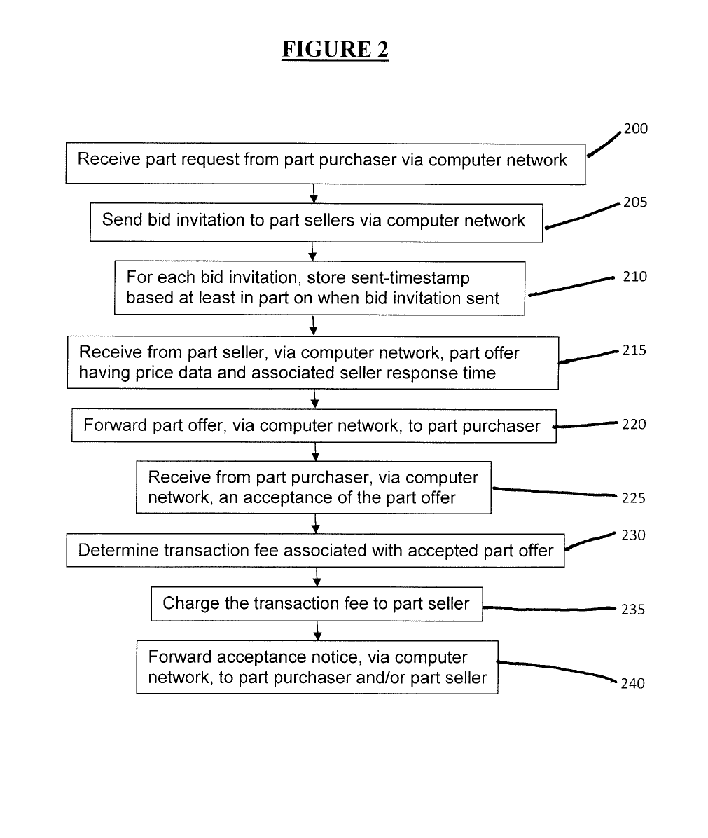

FIG. 2 illustrates an exemplary embodiment of the present invention in which a method of facilitating a vehicular part transaction by a transaction coordinator can include the following: receiving a part request from a part purchaser via a computer network, with the part request including part identification data (block 200); sending a respective bid invitation having the part identification data to a plurality of part sellers via the computer network (block 205); for each respective bid invitation, storing an associated sent-timestamp based at least in part on when the respective bid invitation is sent (block 210); receiving from one of the plurality of part sellers, via the computer network, a part offer having price data and associated seller response time (block 215); forwarding the part offer, via the computer network, to the part purchaser (block 220); receiving from the part purchaser, via the computer network, an acceptance of the part offer (block 225); determining a transaction fee associated with the accepted part offer (block 230); charging the part seller the transaction fee (block 235); and forwarding an acceptance notice, via the computer network, to at least one of the part purchaser and the one of the plurality of part sellers (block 240).

In an exemplary aspect of the present invention, receiving a part request from a part purchaser via a computer network can be effectuated by a part purchaser providing, to a transaction coordinator, part identification data, which can include a part number and/or part information that sufficiently identifies a part, such as for example and not in limitation, vehicle information (e.g., a vehicle identification number, year, make, model, trim level, options, features, etc.), the color of the vehicle or part, a description of the part, the area of the vehicle in which a part is associated, etc. In an exemplary aspect, any type of user interface can be provided by a transaction coordinator so as to facilitate the provisioning of part information. For example, a transaction coordinator can provide a web interface, compatible with browser or similar software executing on a part purchaser's computer, and through which a part purchaser can enter and/or select part identification data and/or part information. Notably, likewise, such an interface can optionally be provided to a part seller.

In another exemplary aspect, a transaction coordinator can send a respective bid invitation having the part identification data to a plurality of part sellers via the computer network. In a further exemplary aspect, part sellers can be registered members, such that their respective contact information is available to a transaction coordinator. Notably, a bid invitation can lack information with which a part purchaser can be identified or contacted, and further, can include a part purchaser identifier or an invitation identifier, which can uniquely identify the specific purchaser or bid invitation for processing purposes.

In an additional exemplary aspect, for each sent bid invitation, a transaction coordinator can store, in one or more memories, a sent-timestamp that is based at least in part on when the respective bid invitation is sent. A sent-timestamp can be determined by a computer clock or counter available directly or indirectly to a transaction coordinator.

In still a further exemplary aspect, a transaction coordinator can receive a respective part offer, via the computer network, from one or more of the plurality of part sellers who received a bid invitation. Accordingly, a part seller having received a bid invitation can send to a transaction coordinator a part offer having price data for the part identified in the bid invitation. Notably, a transaction coordinator can determine a respective response time, which can represent how quickly a part seller responded to a bid invitation. Also, notably, such a determination can be effectuated for a portion or all part offers at any stage after a part offer is received and before a transaction fee is charged. In still another exemplary aspect, a response time can be determined at least in part by when a part offer is received by a transaction coordinator or time-stamped by any computer; and by the stored sent-timestamp associated with the bid invitation initially sent to the part seller. Optionally, a part seller can include additional information regarding a part transaction with a part offer, such as shipping, handling, and delivery logistics, including costs, times, etc.; multi-unit pricing; color and/or size options; etc.

In another exemplary aspect, a transaction coordinator can forward one or more received part offers, via the computer network, to a part purchaser. Notably, a forwarded part offer can include price data, and optionally, additional information provided by a part seller. Also notably, a forwarded part offer can lack information with which a part seller can be identified or contacted, and further, can include a part seller identifier or a part offer identifier.

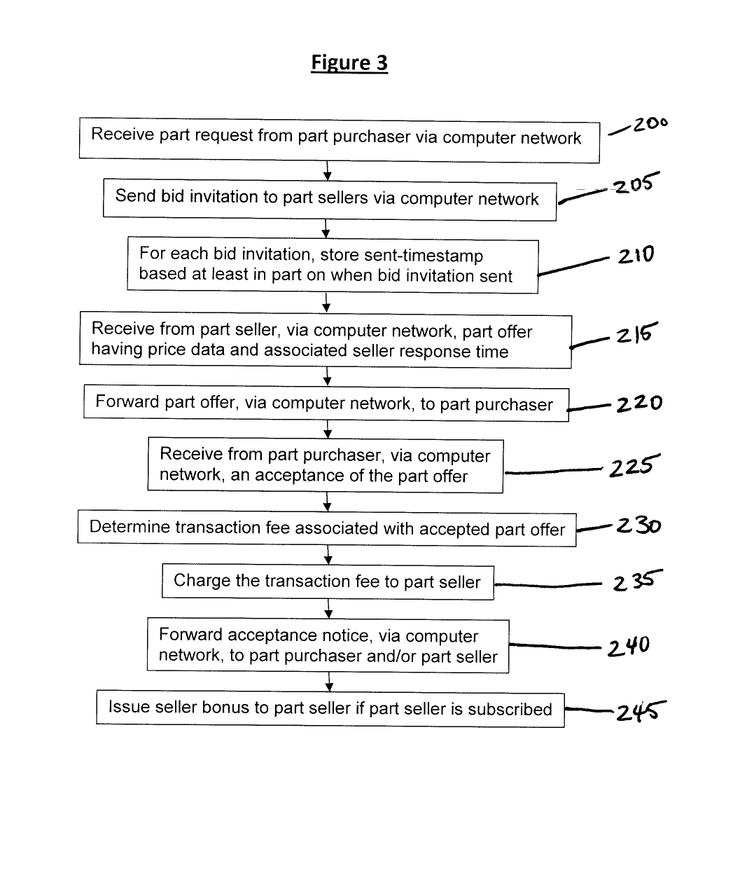

In a further exemplary aspect, a transaction coordinator can receive from a part purchaser, via the computer network, an acceptance of a part offer. Accordingly, in another exemplary aspect, a transaction coordinator can determine a transaction fee associated with the accepted part offer. Such a determination can be based on any formula desired. For example and not in limitation, a determination of a transaction fee can be based on any one or more of the following, in whole or in part: a percentage of the price data; the shipping costs; the handling costs; the transaction amount; a flat fee; a certain number of credits; etc. Moreover, a transaction fee can be reduced in part or in whole. For example, where a part seller is subscribed (e.g., the part seller pays a subscription fee or other consideration, for example and not in limitation), the part seller can be allotted a particular number of free transactions, a particular monetary amount of free transactions, a particular time period of discounted or free transactions, etc., for example and not in limitation. In another exemplary aspect, a transaction fee can be modified if the response time associated with an accepted part offer is within a bonus time, which can be any amount of time desired. For example and not in limitation, an exemplary bonus time can be one (1) minute. Accordingly, if a part seller responds to a bid invitation quickly by sending a part offer that was received by a transaction coordinator within one minute of when the bid invitation was sent, then a corresponding transaction fee can be reduced by a variable or fixed amount, either of which can optionally depend at least in part on anything that could be used to determine the initial transaction fee. Upon final determination, a transaction fee can then be charged to a part seller, who can optionally have a debit account or predefined payment terms, including automatic payment or a billing agreement. Notably, as illustrated in FIG. 3, optionally, where a seller is a subscribed seller, a seller bonus can be issued to a seller whose offer is accepted, with such a bonus being any form of benefit, such as, for example and not in limitation, one or more free or reduced present or future transaction fees, additional subscription time, etc. Also notably, such a seller bonus can be issued if the seller's part offer is received within the bonus time and/or accepted.

In a further exemplary aspect, a transaction coordinator can forward an acceptance notice, via the computer network, to a part purchaser and/or a part seller. In another exemplary aspect, an acceptance notice can include contact information relating to a part purchaser and/or a part seller.

In still another exemplary aspect, a part can be required for operation of a vehicle or may be an accessory, which is not necessary for such operation.

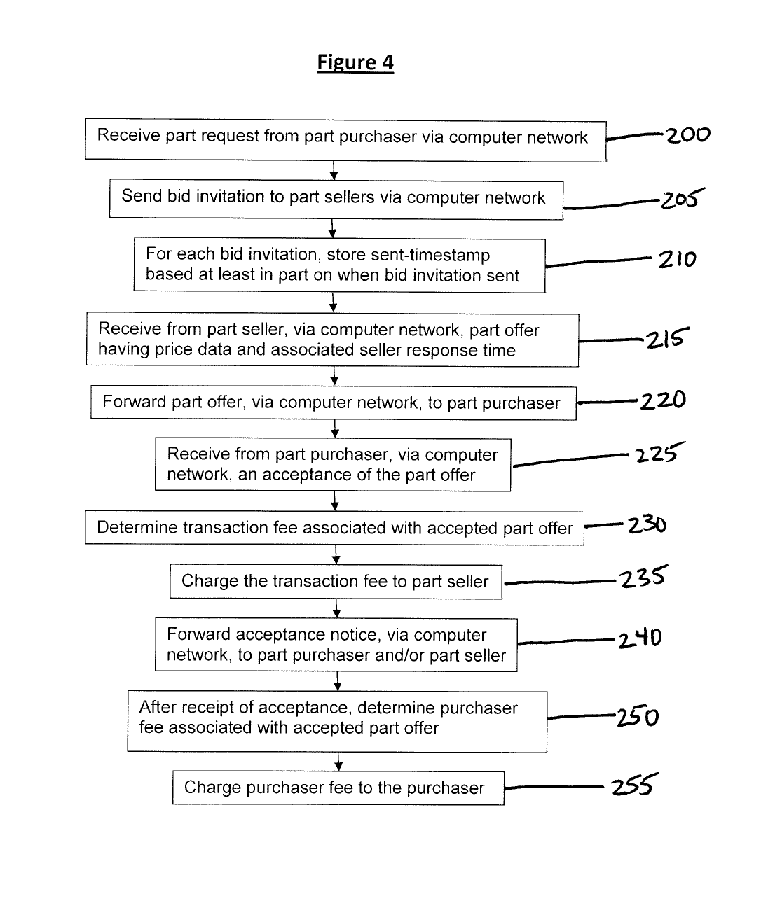

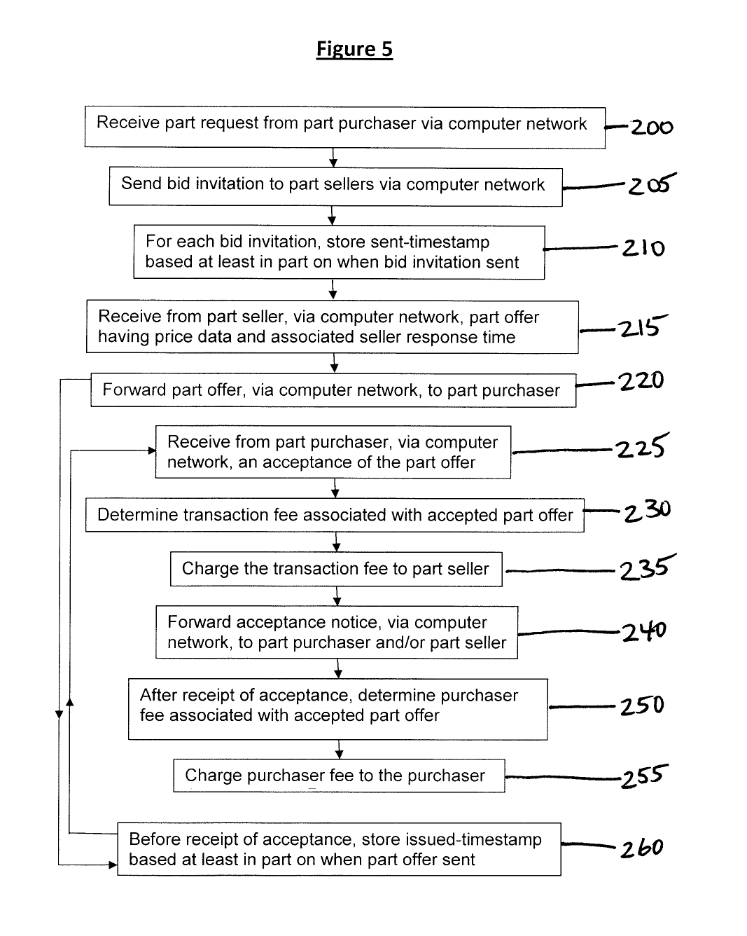

As illustrated in FIG. 4, in a further exemplary aspects of the present invention, a transaction coordinator can optionally determine, and charge a part purchaser, a purchaser fee for an accepted part offer. Such a determination can be based on any formula desired. For example and not in limitation, a determination of a purchaser fee can be based on any one or more of the following, in whole or in part: a percentage of the price data; the shipping costs; the handling costs; the transaction amount; a flat fee; a certain number of credits; etc. Moreover, a purchaser fee can be reduced in part or in whole. For example, where a part purchaser is subscribed (e.g., the part purchaser pays a subscription fee or other consideration, for example and not in limitation), the part purchaser can be allotted a particular number of free transactions, a particular monetary amount of free transactions, a particular time period of free transactions, etc., for example and not in limitation. In another exemplary aspect, a purchaser fee can be modified if the response time in which a part offer is accepted by the part purchaser is within a purchaser bonus time, which can be any amount of time desired. For example and not in limitation, an exemplary purchaser bonus time can be one (1) minute. Accordingly, if a part purchaser accepts a part offer quickly by sending an acceptance within one minute of when the part offer was sent (and/or where a transaction coordinator received such an acceptance within the one minute), then a corresponding purchaser fee can be reduced by a variable or fixed amount, either of which can optionally depend at least in part on anything that could be used to determine the purchaser fee. Upon final determination, a purchaser fee can then be charged to a part purchaser, who can optionally have a debit account or predefined payment terms, including automatic payment or a billing agreement. Notably, as with a seller, optionally, where a purchaser is a subscribed purchaser, a purchaser bonus can be issued to a purchaser, with such a bonus being any form of benefit, such as, for example and not in limitation, one or more free or reduced present or future purchaser fees, additional subscription time, etc. Also notably, such a purchaser bonus can be issued if the part purchaser accepts a part offer within a bonus time. Accordingly, as illustrated in FIG. 5, a transaction coordinator can optionally store an issued-timestamp based at least in part on when a part offer is sent, such that a determination as to whether a part purchaser accepts within the particular bonus time set forth can be assessed. Also optionally, a part purchaser can be provided a discount on the part if such a purchaser accepts within a bonus time.

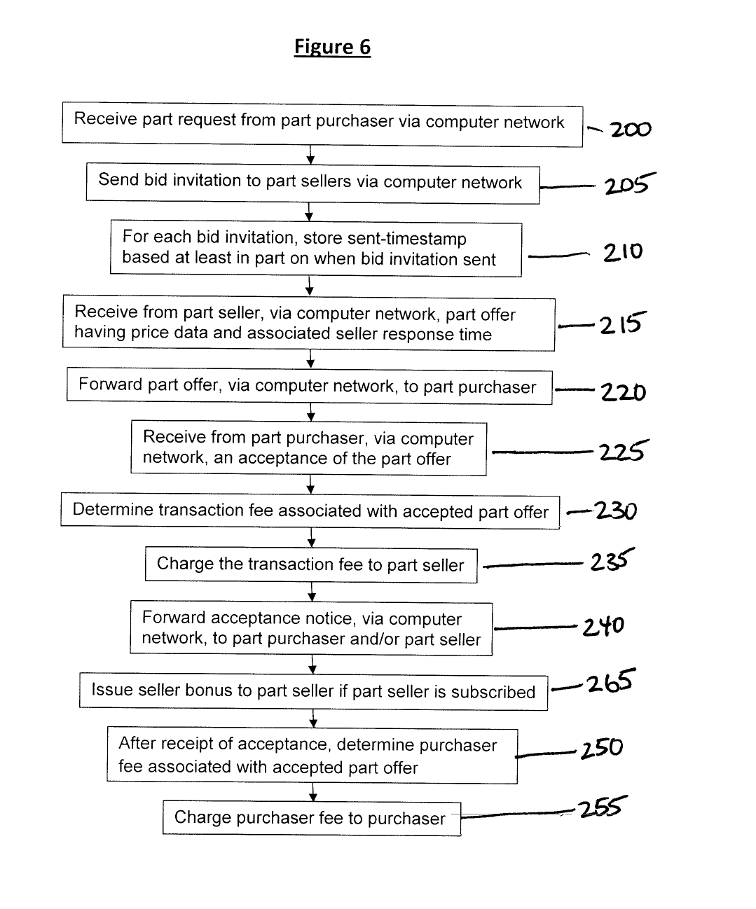

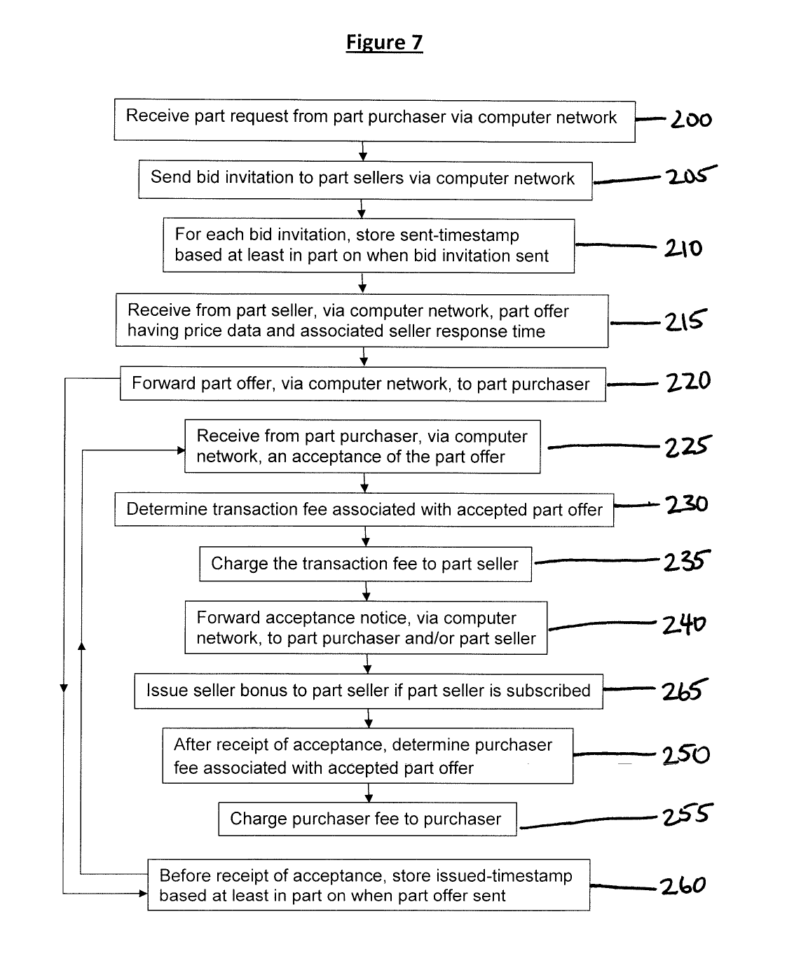

FIGS. 6 and 7 illustrate, and clarify, that a method of the present invention, in which a seller bonus can be issued, can be effectuated with or without storage of an issued-timestamp.

It will be apparent to one of ordinary skill in the art that the manner of making and using the claimed invention has been adequately disclosed in the above-written description of the exemplary embodiments and aspects.

It should be understood, however, that the invention is not necessarily limited to the specific embodiments, aspects, arrangement, and components shown and described above, but may be susceptible to numerous variations within the scope of the invention. For example, the present invention can readily be applied to other types of sales transactions (whether goods or services, or both); and therefore, is not necessarily limited to vehicular part transactions.

Accordingly, the specification and drawings are to be regarded in an illustrative and enabling, rather than a restrictive, sense.

Therefore, it will be understood that the above description of the embodiments of the present invention are susceptible to various modifications, changes, and adaptations, and the same are intended to be comprehended within the meaning and range of equivalents of the appended claims.

Therefore, I claim:

1. In a computer system, a method of facilitating a vehicular part transaction by a transaction coordinator, comprising:
receiving a part request from a part purchaser via a computer network, the part request including part identification data;
sending a respective bid invitation having the part identification data to a plurality of part sellers via the computer network;
for each respective bid invitation, storing an associated sent-timestamp based at least in part on when the respective bid invitation is sent;
receiving from one of the plurality of part sellers, via the computer network, a part offer having price data and a seller response time associated therewith, the seller response time being determined at least in part by when the part offer is received and the stored sent-timestamp associated with the respective bid invitation sent to the one of the plurality of part sellers;
forwarding the part offer, via the computer network, to the part purchaser;
receiving from the part purchaser, via the computer network, an acceptance of the part offer;
determining a transaction fee associated with the accepted part offer;
charging the one of the plurality of part sellers the transaction fee; and
forwarding an acceptance notice, via the computer network, to at least one of the part purchaser and the one of the plurality of part sellers;
wherein said determining of the transaction fee includes reducing the transaction fee if the seller response time associated with the accepted part offer is within a seller bonus time.

2. The method of claim 1, further comprising:
issuing a seller bonus to the one of the plurality of part sellers if the one of the plurality of part sellers is a subscribed seller.

3. The method of claim 1, wherein the transaction fee is reduced if the one of the plurality of part sellers is a subscribed seller.

4. The method of claim 1, further comprising:
after said receiving the acceptance, determining a purchaser fee associated with the accepted part offer; and
charging the purchaser fee to the part purchaser.

5. The method of claim 4, further comprising:
before said receiving the acceptance, storing an issued-timestamp based at least in part on when the respective bid invitation is sent;
wherein the acceptance of the part offer includes a purchaser response time associated therewith, and said determining of the purchaser fee includes reducing the purchaser fee if the purchaser response time associated with the acceptance is within a purchaser bonus time.

6. The method of claim 4, wherein the purchaser fee is reduced to zero if the purchaser is a subscribed purchaser.

7. The method of claim 4, wherein the purchaser fee is reduced to zero if the purchaser is a subscribed purchaser and a number of completed transactions associated with the purchaser is within an allotted number of purchases associated with the purchaser.

8. The method of claim 4, wherein the purchaser fee is reduced if the purchaser is a subscribed purchaser and a total fee amount charged to the purchaser is less than an allotted amount associated with the purchaser.

9. The method of claim 4, wherein the purchaser fee is reduced to zero if the purchaser is a subscribed purchaser and a total fee amount charged to the purchaser plus the transaction fee is less than an allotted amount associated with the purchaser.

10. The method of claim 1, wherein the transaction fee is reduced to zero if the one of the plurality of part sellers is a subscribed seller.

11. The method of claim 1, wherein the transaction fee is reduced to zero if the one of the plurality of part sellers is a subscribed seller and a number of completed transactions associated with the one of the plurality of part sellers is within an allotted number of transactions.

12. The method of claim 1, wherein the transaction fee is reduced if the one of the plurality of part sellers is a subscribed seller and a total fee amount charged to the one of the plurality of part sellers is less than an allotted amount associated with the one of the plurality of part sellers.

13. The method of claim 1, wherein the transaction fee is reduced to zero if the one of the plurality of part sellers is a subscribed seller and a total fee amount charged to the one of the plurality of part sellers plus the transaction fee is less than an allotted amount associated with the one of the plurality of part sellers.

14. The method of claim 2, further comprising:
after said receiving the acceptance, determining a purchaser fee associated with the accepted part offer; and
charging the purchaser fee to the part purchaser.

15. The method of claim 14, further comprising:
before said receiving of the acceptance, storing an issued-timestamp based at least in part on when the respective bid invitation is sent;
wherein the acceptance of the part offer includes a purchaser response time associated therewith, and said determining of the purchaser fee includes reducing the purchaser fee if the purchaser response time associated with the acceptance is within a purchaser bonus time.

16. The method of claim 14, wherein the purchaser fee is reduced to zero if the purchaser is a subscribed purchaser.

17. The method of claim 14, wherein the purchaser fee is reduced to zero if the purchaser is a subscribed purchaser and a number of completed transactions associated with the purchaser is within an allotted number of purchases associated with the purchaser.

18. The method of claim 14, wherein the purchaser fee is reduced if the purchaser is a subscribed purchaser and a total fee amount charged to the purchaser is less than an allotted amount associated with the purchaser.

19. The method of claim 14, wherein the purchaser fee is reduced to zero if the purchaser is a subscribed purchaser and a total fee amount charged to the purchaser plus the transaction fee is less than an allotted amount associated with the purchaser.
